(19) United States
(12) Patent Application Publication
(10) Pub. No.: US 2010/0125704 A1
(43) Pub. Date: May 20, 2010

(54) STORAGE CONTROL APPARATUS AND STORAGE SYSTEM

(75) Inventor: Hiroki Kanai, Odawara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/348,063

(22) Filed: Jan. 2, 2009

(30) Foreign Application Priority Data
Nov. 17, 2008 (JP) 2008-293330

(51) Int. Cl. G06F 12/08; G06F 12/00

(52) U.S. Cl. 711/113; 711/E12.001; 711/E12.019

(57) ABSTRACT

Provided is a storage control apparatus, including a Central Processing Unit, a channel interface device, a disk interface device, and an input/output control device. In the storage control apparatus, a main memory device is configured by a battery-backed-up volatile memory that can maintain the nonvolatility of data for a predetermined period of time after the power supply is turned off. By the battery-backed-up main memory device and a memory device of the input/output control device, a memory address space is formed to make it serve as a cache device of the storage control apparatus, and staging and destaging processes are executed between the cache device and the disk drive unit. In such a storage control apparatus being coupled to a host computer and a storage device to control data input/output to/from the storage device, memory devices therein can be used with a good efficiency, and data input/output control can be performed with high reliability and swiftness.

### CROSS REFERENCES TO RELATED APPLICATIONS

This application relates to and claims priority from Japanese Patent Application No. 2008-293330, filed on Nov. 17, 2008, the entire disclosure of which is incorporated herein by reference.

### BACKGROUND OF THE INVENTION

1. Field of the Invention

The present invention relates to a storage control apparatus and a storage system with which the use efficiency of a memory is increased in a control device in charge of data input/output to/from a storage device.

2. Description of the Related Art

There is a technology of making use of a plurality of memories, e.g., disk memories and cache memories, for control over data input/output to/from a storage device provided therein with a plurality of disk drives. As such a technology, Patent Document 1 (JP-A-59-135563) describes, for example, a computer system in which a disk/cache device to be coupled to a disk control device is configured by a portion of nonvolatile memory and a portion of volatile memory. With such a computer system, an output process from a Central Processing Unit is completed when data writing to the nonvolatile portion in the disk/cache device is finished, and a plurality of data pieces on the nonvolatile portion in the disk/cache device are collectively written into the disk drive.

Patent Document 2 (JP-A-2005-301419) describes, for example, a disk array device in which a data transfer control section transfers write data coming from a host computer/server to both a nonvolatile memory section and a global cache memory section via a switch section for dual writing of the data. This is aimed to enhance the device capabilities by implementing dual writing of data while reducing the frequency of a write process to a cache memory.

FIG. 11 shows an exemplary schematic overall view of a previous exemplary storage system provided therein with a nonvolatile memory. In the storage system, a storage control apparatus CTL including a plurality of controllers (CTL0, CTL1) performs data writing and reading control, i.e., input/output control, over a disk drive unit in response to an input/output command from a host computer. For example, the storage control device CTL0 stores an application program in a main memory device, i.e., volatile memory 1, and performs various types of controls in response to commands coming from a Central Processing Unit (CPU). Using the application program, i.e., an input/output control program, software control can be performed over data input/output by CPU's command control.

Using an interface controller, i.e., channel IFCTL, specifically provided for establishing a coupling with the host computer, and using an interface controller, i.e., disk IFCTL, specifically provided for establishing a coupling with a hard disk drive, a control circuit (IOCTL) specifically provided for control over data input/output can perform input/output hardware control. Such a data input/output control circuit is coupled with a nonvolatile (data remains intact even after the power supply is turned off) cache memory, i.e., nonvolatile memory 2. With such a coupling, for example, the cache memory can temporarily store therein data coming from the host computer, and the data in the cache memory can be then written to the hard disk drive, i.e., destaging control, and the cache memory can store therein data read from the hard disk drive, and the data is transferred to the host computer, i.e., staging control.

With a volatile memory, any data stored therein will be erased when the power supply is turned off, e.g., DRAM (Dynamic Random Access Memory) used in a main memory of a computer, for example. On the other hand, with a nonvolatile memory, any data stored therein remains intact even if the power supply is turned off, e.g., Flash memory, magnetic disk memory, or battery-backed-up memory. The battery-backed-up memory can maintain the nonvolatility of data by backing up a volatile memory using a power supply. For input/output control over the storage control apparatus, generally used is a battery-backed-up cache memory, i.e., memory 2, which is a volatile memory that can maintain the nonvolatility of data for a predetermined period of time by a battery or a power supply of a storage battery.

### SUMMARY OF THE INVENTION

A volatile memory is generally slow in input/output speed of data, and any data stored therein is erased when the power supply is turned off. On the other hand, a nonvolatile memory is high in performance, i.e., generally fast in input/output speed of data, and any data stored therein remains intact even if the power supply is turned off, but is relatively high in cost. In a storage control apparatus needed to use a large number of cache memories, it is significant for a memory device therein to select an appropriate memory configuration.

Moreover, at the time of input/output control over the storage control apparatus, data input/output control over destaging and staging between a cache memory and a hard disk drive has to be appropriately performed depending on whether data on the cache memory is clean data or dirty data. The clean data is the one already written to the hard disk drive, and does not cause any fatal damage even if it is erased. On the other hand, the dirty data is the one being updated and existing only on the cache memory, for example, and is not able to be recovered if it is erased. Such input/output control over the storage control apparatus is also required to be flexibly performed depending on whether data being a target of input/output control is control data or storage data. The control data is the one that will cause trouble in terms of controlling if it is erased, and the storage data is the one merely stored by a user.

The technologies of Patent Documents 1 and 2 above are both those in which a disk/cache device is configured by a portion of nonvolatile memory and a portion of volatile memory, or data is stored into both a nonvolatile cache memory and an external global cache device. Neither of Patent Documents 1 and 2 describes changing memory storage means and storage method depending on the type of information to be stored.

In consideration thereof, an object of the invention is to achieve, in a storage control apparatus coupled to both a host computer and a storage device, and performing control over data input/output to/from the storage device in response to a command coming from the host computer, the efficient use of memory devices therein, and the data input/output control with high reliability and swiftness.

A first aspect of the invention is directed to a storage control apparatus that includes: a central processing unit coupled with a main memory device; a channel interface device to be coupled with a host computer; a disk interface device to be coupled with a disk drive unit; and an input/output control device coupled with a memory device. In the storage control apparatus, the main memory device is configured by a volatile memory that is battery backed-up to maintain nonvolatility of data for a predetermined period of time after a power supply is turned off, the battery-backed-up main memory device and the memory device coupled with the input/output control device form a memory address space for use as a cache device of the storage control apparatus, a staging process is executed for reading data stored in the disk drive unit, and for writing the data into the cache device, and a destaging process is executed for reading data stored in the cache device, and for writing the data into the disk drive unit.

A second aspect of the invention is directed to a storage control apparatus that includes: a central processing unit coupled with a main memory device; a channel interface device to be coupled with a host computer; a disk interface device to be coupled with a disk drive unit; and an input/output control device coupled with a memory device. In the storage control apparatus, the main memory device and the memory device coupled with the input/output control device are each configured by a volatile memory that is battery backed-up to maintain nonvolatility of data for a predetermined period of time after a power supply is turned off, the battery-backed-up main memory device and the battery-backed-up memory device coupled with the input/output control device form a memory address space for use as a cache device of the storage control apparatus, a staging process is executed for reading data stored in the disk drive unit, and for writing the data into the cache device, and a destaging process is executed for reading data stored in the cache device, and for writing the data into the disk drive unit.

A third aspect of the invention is directed to a storage system that includes: a plurality of storage control apparatus each including: a central processing unit coupled with a main memory device; a channel interface device to be coupled with a host computer; a disk interface device to be coupled with a disk drive unit; and an input/output control device coupled with a memory device; the host computer coupled with each of the storage control apparatuses via the channel interface devices thereof; and the disk drive unit coupled with each of the storage control apparatuses via the disk interface devices thereof. In the storage system, the main memory device and the memory device coupled with the input/output control device of each of the plurality of storage control apparatuses are each configured by a volatile memory that is battery backed-up to maintain nonvolatility of data for a predetermined period of time after a power supply is turned off, the battery-backed-up main memory device and the battery-backed-up memory device coupled with the input/output control device of the storage system, and a battery-backed-up main memory device and a battery-backed-up memory device coupled with an input/output control device of an other system form a memory address space for use as a cache device of the storage system, a staging process is executed for reading data stored in the disk drive unit, and for writing the data into the cache device, and a destaging process is executed for reading data stored in the cache device, and for writing the data into the disk drive unit.

According to the aspects of the invention, the use efficiency can be increased for memories for use with input/output control of a storage control apparatus and a storage system. Moreover, in the storage control apparatus, input/output control over staging and destaging between the cache memory and the storage device can be performed with high reliability and swiftness.

### BRIEF DESCRIPTION OF THE DRAWINGS

FIG. 1 is a schematic overall view of a storage system provided therein with a storage control apparatus in a first embodiment of the invention;

FIG. 2 is a diagram showing an exemplary storage area management table showing the configuration of a memory space in the storage control apparatus of the invention;

FIG. 3 is a schematic overall view of a storage system provided therein with a storage control apparatus in a second embodiment of the invention;

FIG. 4 is a schematic overall view of a storage system provided therein with a storage control apparatus in a third embodiment of the invention;

FIG. 5 is a detailed flowchart of a host input/output (IO) process to be executed in the storage control apparatus of the invention;

FIG. 6 is a detailed flowchart of a data write (Write) process to be executed in the storage control apparatus of the invention;

FIG. 7 is a detailed flowchart of a storage area reservation process in the data write (Write) process to be executed in the storage control apparatus of the invention;

FIG. 8 is a detailed flowchart of a data read (Read) process to be executed in the storage control apparatus of the invention;

FIG. 9 is a detailed flowchart of a storage area reservation process in the data read (Read) process to be executed in the storage control apparatus of the invention;

FIG. 10 is a detailed flowchart of a drive data transfer process for data back-up to be executed in the storage control apparatus of the invention, and for remote copy therein; and

FIG. 11 is a schematic overview of a previous exemplary storage system provided therein with a nonvolatile memory.

### DESCRIPTION OF THE PREFERRED EMBODIMENTS

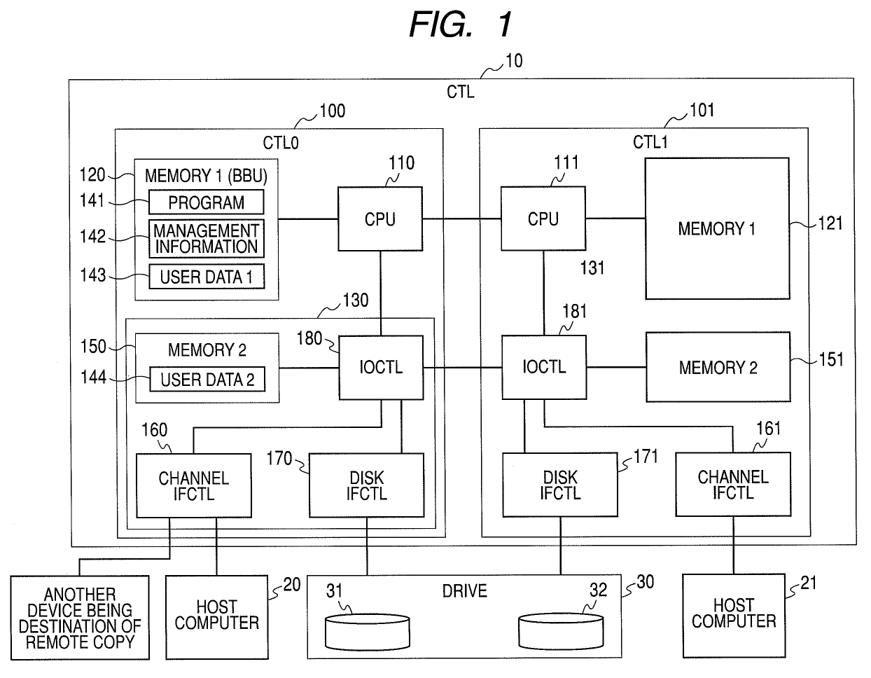

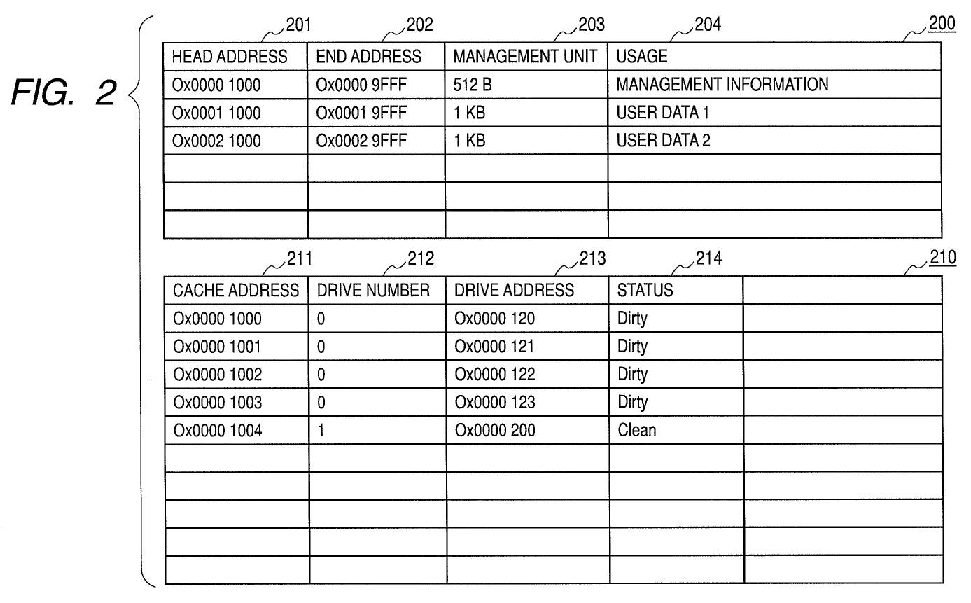

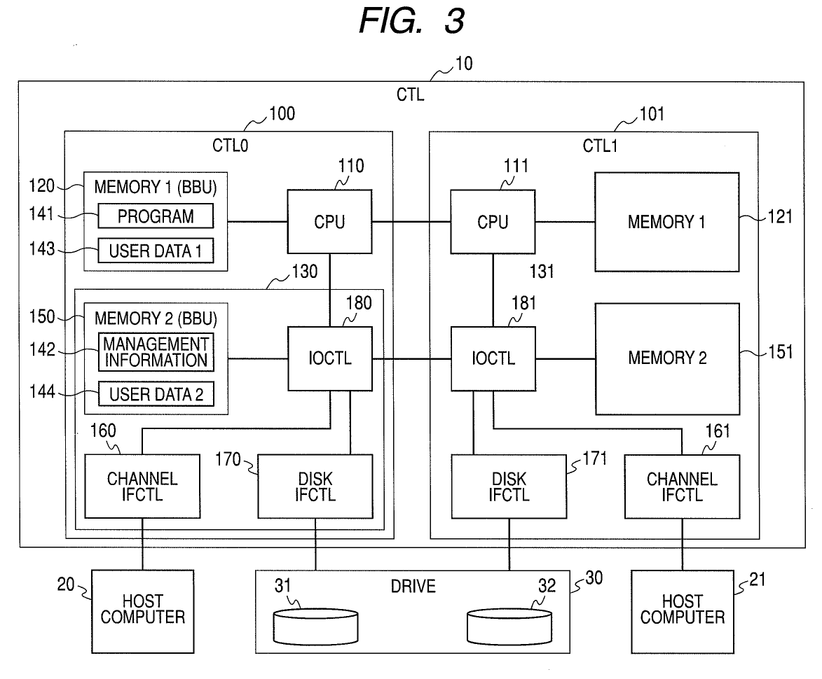

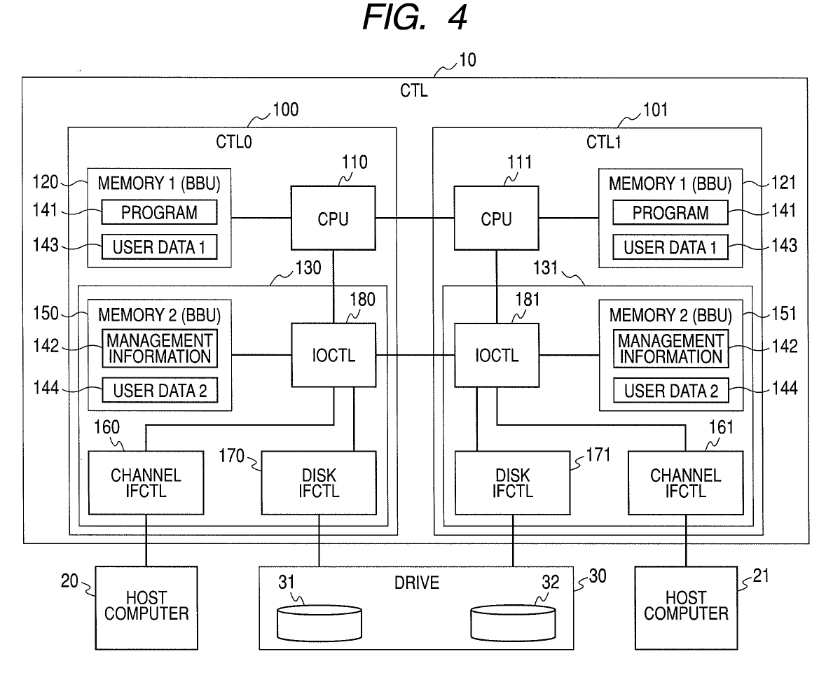

In the below, embodiments of the invention are described by referring to the accompanying drawings. FIG. 1 is a schematic overall view of a storage system provided therein with a storage control apparatus in a first embodiment, and FIG. 2 shows an exemplary storage area management table showing the configuration of a memory space in the storage control apparatus. FIG. 3 is a schematic overall view of a storage system provided therein with a storage control apparatus in a second embodiment, and FIG. 4 is a schematic overall view of a storage system provided therein with a storage control apparatus in a third embodiment.

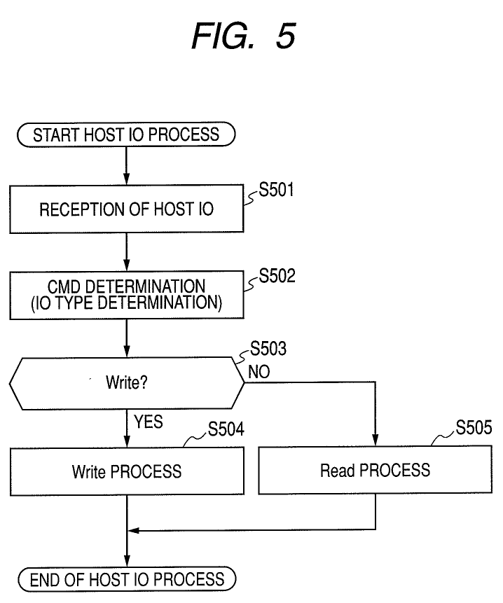

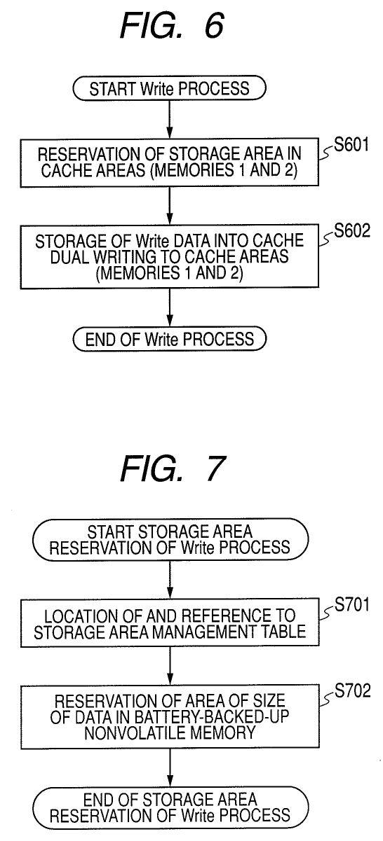

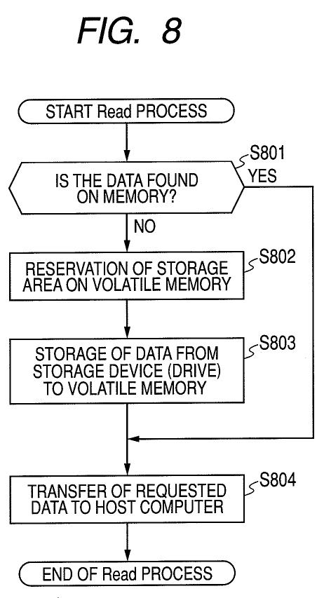

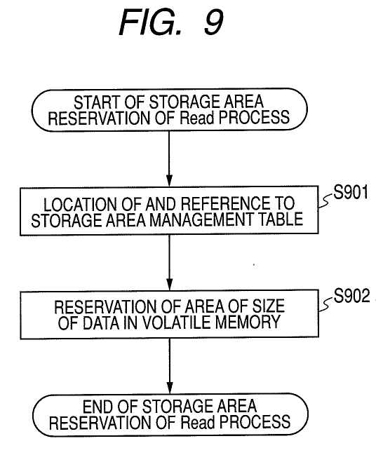

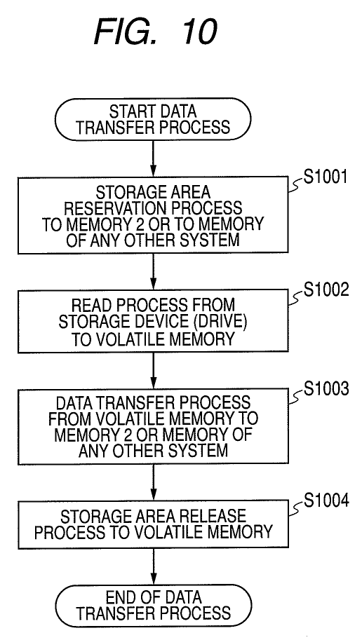

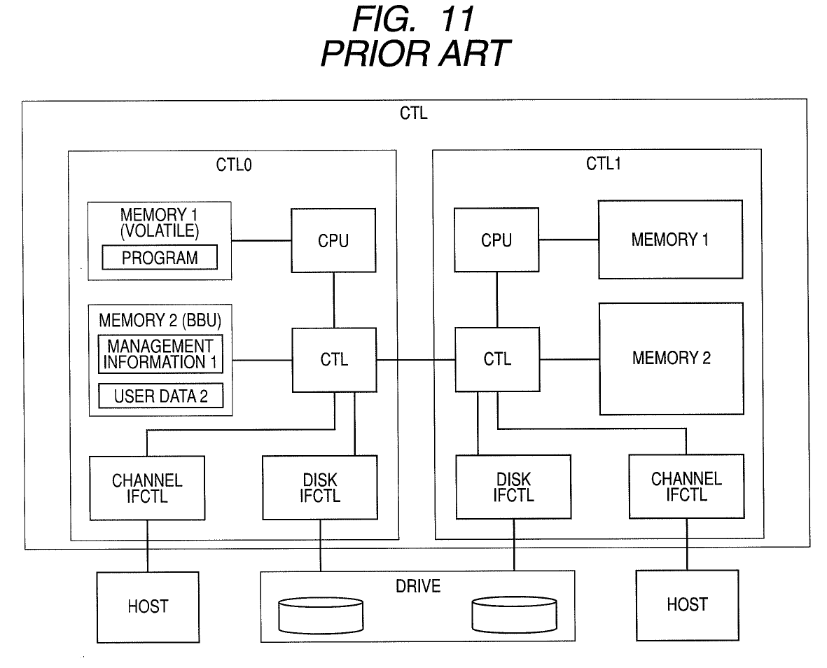

FIGS. 5 to 10 are detailed flowcharts respectively of processes to be executed in the storage control apparatus of the invention. Specifically, FIG. 6 is a flowchart of a data write (Write) process, and FIG. 7 is a flowchart of a storage area reservation process at the time of data writing. FIG. 8 is a flowchart of a data read (Read) process, FIG. 9 is a storage area reservation process at the time of data reading, and FIG. 10 is a flowchart of a drive data transfer process for data back-up and for remote copy.

### First Embodiment

FIG. 1 is a schematic overall view of a storage system provided therein with a storage control apparatus in the first embodiment of the invention. FIG. 2 shows an exemplary storage area management table showing the configuration of a memory space in the storage control apparatus of the invention.

In FIG. 1, a reference numeral 10 denotes a storage control system, reference numerals 20 and 21 each denote a host computer, a reference numeral 30 denotes a storage device (drive), reference numerals 31 and 32 each denote a disk drive, reference numerals 100 and 101 each denote a storage control apparatus, reference numerals 110 and 111 each denote a Central Processing Unit (CPU), reference numerals 120 and 121 each denote a main memory device (memory 1), reference numerals 130 and 131 each denote an input/output control module (IO module), a reference numeral 141 denotes a program, a reference numeral 142 denotes management information, a reference numeral 143 denotes user data 1, a reference numeral 144 denotes user data 2, reference numerals 150 and 151 each denote a cache memory (memory 2), reference numerals 160 and 161 each denote a channel interface device (channel IFCTL), reference numerals 170 and 171 each denote a disk interface device (disk IFCTL), and reference numerals 180 and 181 each denote an input/output control device (IOCTL).

In the first embodiment, FIG. 1 shows an example in which the input/output control module (IO module) 130 is configured by the input/output control device (IOCTL) 180, the channel interface device (channel IFCTL) 160, and the disk interface device (disk IFCTL) 170. This is only an example, and the invention is surely not restrictive to such an example of module mounting of FIG. 1. Alternatively, these components may be mounted as each separate module, or the input/output control device (IOCTL) 180 and the CPU 110 may be mounted on any same substrate, and the channel interface device (channel IFCTL) 160 and the disk interface device (disk IFCTL) 170 may be mounted as each separate module, for example.

The storage control apparatus 100 in the first embodiment of the invention is configured to include the Central Processing Unit (CPU) 110 including the memory (1) 120 being a main memory device, the channel interface device (channel IFCTL) 160 for coupling with the host computer 20, the disk interface device (disk IFCTL) 170 for coupling with the storage device 30, the memory (2) 150 being a cache memory, and the input/output control module (IO module) 130 including the input/output control device (IOCTL) 180 for input/output control.

In the first embodiment of the invention, the main memory device (memory 1) 120 is configured by a volatile memory that is backed up to maintain the nonvolatility of data for a predetermined period of time by a battery or power stored in a storage battery, i.e., any data stored therein can remain intact for a predetermined period of time even if the power supply is turned off. The battery-backed-up (BBU) main memory device (memory 1) stores therein the program 141, the management information 142, and the user data (1) 143, and by the program 141 stored in the main memory device (memory 1) as such, the Central Processing Unit (CPU) 110 can operate any application program during the predetermined period of time of BBU.

With the program 141, i.e., input/output control program for the storage control apparatus, stored as such, even if the power supply is turned off, software control can be performed during the predetermined period of time of BBU, i.e., the Central Processing Unit (CPU) 110 runs the input/output control program, refers to the management information 143 stored in the main memory device (memory 1) 120, and controls the input/output module 130, thereby inputting/outputting the user data 1 and 2 to/from any predetermined memory device.

FIG. 2 shows an exemplary storage area management table, which is located at the time of data input/output control and shows the configuration of a memory space in the storage control apparatus. In FIG. 2, a reference numeral 200 denotes a memory management table, a reference numeral 201 denotes a head address, a reference numeral 202 denotes an end address, a reference numeral 203 denotes a management unit, a reference numeral 204 denotes usage, a reference numeral 210 denotes a memory address data table, a reference numeral 211 denotes a cache address, a reference numeral 212 denotes a drive number, a reference numeral 213 denotes a drive address, and a reference numeral 214 denotes a status.

The memory management table 200 includes columns of “head address 201”, “end address 202”, “management unit 203”, and “usage 204”. The columns of “head address 201” and “end address 202” each store the address position of data for input/output control on a memory space, and the column of “management unit 203” stores a management unit indicating the size of the input/output control data. The column of “usage 204” stores usage information about whether the input/output control data is management information including control data or user data.

The memory address data table 210 includes columns of “cache address 211”, “drive number 212”, “drive address 213”, and “status 214”, and manages data and information stored therein. That is, the column of “cache address 211” stores the cache address in a memory space of a cache device including the backed-up main memory device (memory 1) and the cache memory (memory 2). The column of “drive number 212” stores a drive number for use to identify the storage device (disk) 30 corresponding to the data stored at the cache address, and the column of “drive address 213” stores a drive address in the memory space of the storage device (disk) 30. The column of “status 214” stores status information about a “Dirty state” in which any stored data exists only in the cache devices (memories 1 and 2), and a “Clean state” in which the stored data exists in all the cache devices (memories 1 and 2) and the storage device (disk) 30.

In the storage control apparatus, if software control is to be performed, i.e., the Central Processing Unit (CPU) is in charge of data input/output control, or if hardware control is to be performed, i.e., the input/output control device (IOCTL) specifically provided for the input/output module (IO module) 130 performs data input/output control, the storage area management table is located and referred to so that the storage process of the input/output process is executed without fail. The storage area management table is the one stored in the memory 1 or 2 for showing the configuration of a memory space of the storage control apparatus. After the storage process of the input/output process is executed without fail as such, the processes, i.e., data write (Write) process, data read (Read) process, and data transfer process, are executed.

### Second Embodiment

FIG. 3 shows a schematic overall view of a storage system provided therein with a storage control apparatus in a second embodiment of the invention. In FIG. 3, the reference numeral 10 denotes a storage control system, the reference numerals 20 and 21 each denote a host computer, the reference numeral 30 denotes a storage device (drive), the reference numerals 31 and 32 each denote a disk drive, the reference numerals 100 and 101 each denote a storage control apparatus, the reference numerals 110 and 111 each denote a Central Processing Unit (CPU), the reference numerals 120 and 121 each denote a main memory device (memory 1), the reference numerals 130 and 131 each denote an input/output control module (IO module), the reference numeral 141 denotes a program, the reference numeral 142 denotes management information, the reference numeral 143 denotes user data 1, the reference numeral 144 denotes user data 2, the reference numerals 150 and 151 each denote a cache memory (memory 2), the reference numerals 160 and 161 each denote a channel interface device (channel IFCTL), the reference numerals 170 and 171 each denote a disk interface device (disk IFCTL), and the reference numerals 180 and 181 each denote an input/output control device (IOCTL). As such, the components in the second embodiment same as those in the first embodiment are provided with the same reference numerals.

In the second embodiment, FIG. 3 shows an example in which the input/output control module (IO module) 130 is configured by the input/output control device (IOCTL) 180, the channel interface device (channel IFCTL) 160, and the disk interface device (disk IFCTL) 170. This is only an example, and the invention is surely not restrictive to such an example of module mounting of FIG. 3. Alternatively, these components may be mounted as each separate module, or the input/output control device (IOCTL) 180 and the CPU 110 may be mounted on any same substrate, and the channel interface device (channel IFCTL) 160 and the disk interface device (disk IFCTL) 170 may be mounted as each separate module, for example.

The storage control apparatus 100 in the second embodiment of the invention is configured to include the Central Processing Unit (CPU) 110 including the memory (1) 120 being a main memory device, the channel interface device (channel IFCTL) 160 for coupling with the host computer 20, the disk interface device (disk IFCTL) 170 for coupling with the storage device 30, the memory (2) 150 being a cache memory, and the input/output control module (IO module) 130 including the input/output control device (IOCTL) 180 for input/output control.

In the first embodiment of the invention described above, the main memory device (memory 1) 120 is configured by a battery-backed-up volatile memory. On the other hand, in the storage control apparatus in the second embodiment of the invention, not only the main memory device (memory 1) 120 but also the cache memory (memory 2) 150 are configured by battery-backed-up volatile memories. In the configuration, the main memory device (memory 1) 120 and the cache memory (memory 2) 150 both are so configured as to maintain the nonvolatility of data for a predetermined period of time by a battery or power stored in a storage battery, i.e., any data stored therein remains intact for a predetermined period of time even if the power supply is turned off, and both serve as cache devices. Alternatively, the battery-backed-up main storage unit (memory 1) 120 may be so configured as to serve as a sub memory of the battery-backed-up cache memory (memory 2) 150.

In the second embodiment of the invention, the battery-backed-up (BBU) main memory device (memory 1) stores therein the program 141, and the user data (1) 143, and the battery-backed-up cache memory (memory 2) 150 stores therein the management information 142 and the user data 2.

During a predetermined period of time of BBU, the input/output control device (IOCTL) of the input/output control module (IO module) 130 can perform various types of input/output control by hardware control incorporated in the input/output control device (IOCTL), i.e., input/output control over data between the storage device (drive) 30 and the main memory device (memory 1) 120 or the cache memory (memory 2) 150, or input/output control over data between the main memory device (memory 1) 120 and the cache memory (memory 2) 150. Such input/output control is performed through reference to the management information stored in the battery-backed-up cache memory (memory 2) 150 in response to an input/output command coming from the host computer 20.

### Third Embodiment

FIG. 4 is a schematic overall view of a storage system including a storage control apparatus in a third embodiment of the invention. In FIG. 4, the reference numeral 10 denotes a storage control system, the reference numerals 20 and 21 each denote a host computer, the reference numeral 30 denotes a storage device (drive), the reference numerals 31 and 32 each denote a disk drive, the reference numerals 100 and 101 each denote a storage control apparatus, the reference numerals 110 and 111 each denote a Central Processing Unit (CPU), the reference numerals 120 and 121 each denote a main memory device (memory) 1, the reference numerals 130 and 131 each denote an input/output control module (IO module), the reference numeral 141 denotes a program, the reference numeral 142 denotes management information, the reference numeral 143 denotes user data 1, the reference numeral 144 denotes user data 2, the reference numerals 150 and 151 each denote a cache memory (memory 2), the reference numerals 160 and 161 each denote a channel interface device (channel IFCTL), the reference numerals 170 and 171 each denote a disk interface device (disk IFCTL), and the reference numerals 180 and 181 each denote an input/output control device (IOCTL). As such, the components in the third embodiment same as those in the first embodiment are provided with the same reference numerals.

In the third embodiment, FIG. 4 shows an example in which the input/output control modules (IO modules) 130 and 131 are respectively configured by the input/output control devices (IOCTLs) 180 and 181, the channel interface devices (channel IFCTLs) 160 and 161, and the disk interface devices (disk IFCTLs) 170 and 171. This is only an example, and the invention is surely not restrictive to such an example of module mounting of FIG. 4. Alternatively, these components may be mounted as each separate module, or the input/output control devices (IOCTLs) 180 and 181 and the CPUs 110 and 111 may be mounted on any same substrate, and the channel interface devices (channel IFCTLs) 160 and 161 and the disk interface devices (disk IFCTLs) 170 and 171 maybe mounted as each separate module, for example.

The storage control apparatus 100 in the third embodiment of the invention is configured to include the Central Processing Unit (CPU) 110 including the memory (1) 120 being a main memory device, the channel interface device (channel IFCTL) 160 for coupling with the host computer 20, the disk interface device (disk IFCTL) 170 for coupling with the storage device 30, the memory (2) 150 being a cache memory, and the input/output control module (IO module) 130 including the input/output control device (IOCTL) 180 for input/output control.

In the first or second embodiment of FIG. 1 or 3, in either the storage control apparatus 100 or 101 of the storage control system 10, i.e., only in the storage control apparatus 100, the main memory device (memory 1) 120 is configured by a battery-backed-up volatile memory to maintain the nonvolatility of data for a predetermined period of time by a battery or power stored in a storage battery, i.e., any data stored therein remains intact for a predetermined period of time even if the power supply is turned off. In the storage control apparatus 101 of any other system, such a configuration of the battery-backed-up volatile memory is not adopted.

In the third embodiment of the invention, as shown in FIG. 4, in each of the storage control apparatuses 100 and 101, both the main memory device (memory 1) 120 and the cache memory (memory 2) are configured by battery-backed-up volatile memories to maintain the nonvolatility of data for a predetermined period of time by a battery or power stored in a storage battery, i.e., any data stored therein remains intact for a predetermined period of time even if the power supply is turned off.

In the third embodiment of the invention, for dual writing of data, not only the main memory device (memory 1) 120 and the cache memory (memory 2) in the storage control apparatus 100 of its own but also those in the storage control apparatus 101 of any other system, i.e., the main memory device (memory 1) 120 and the cache memory (memory 2), can be used as cache devices. Moreover, the storage control apparatus 101 of any other system can be provided plurally so that the memory space can be considerably increased in size in the cache devices in charge of data input/output control as a storage system.

### Control Flow of Storage Control Apparatus

In the below, described are the details of the processes to be executed in the storage control apparatus of the invention. FIGS. 5 to 10 are detailed flowcharts respectively of processes to be executed in the storage control apparatuses in the first to third embodiments of the invention. Specifically, FIG. 6 is a flowchart of a data write (Write) process, and FIG. 7 is a flowchart of a storage area reservation process at the time of data writing. FIG. 8 is a flowchart of a data read (Read) process, FIG. 9 is a storage area reservation process at the time of data reading, and FIG. 10 is a flowchart of a drive data transfer process for data back-up and for remote copy.

FIG. 5 is a detailed flowchart of a host input/output (IO) process to be executed in the storage control apparatus of the invention. In FIG. 5, when the host IO process is started, in step 501, an input/output command (IO) coming from the host computer 20 is received, and a CMD (Command) process is then executed for making an IO type determination, i.e., determining whether the command is for a write (Write) process or for a read (Read process). The host IO process can be executed through hardware control by the input/output control device (IOCTL) 180 of the input/output control module (IO module) 130. Moreover, even after the power is turned off, during a predetermined period of time of BBU, the host IO process can be performed by software control by the Central Processing Unit (CPU) 110 using the input/output control program 141 stored in the battery-backed-up main memory (memory 1).

Then in step 503, when the command is for the write (Write) process, i.e., Yes, the procedure goes to step 504, and the write (Write) process is accordingly executed, thereby ending the host input/output (IO) process. On the other hand, when the command is not for the write (Write) process in step 503, i.e., No, the procedure goes to step 505, and the read (Read process) is executed, thereby ending the host input/output (IO) process.

FIG. 6 is a detailed flowchart of the data write (Write) process to be executed in the storage control apparatus of the invention. The data write (Write) process of FIG. 6 corresponds to step 504 of the host IO process of FIG. 5.

In FIG. 6, when the data write (Write) process is started, in step 601, a storage area is reserved in the cache areas (memories 1 and 2). In the first embodiment, a storage area is reserved in the cache area of the battery-backed-up main memory device (memory 1), and that of the cache memory (memory 2) in the input/output module (IO module) 130. In the second embodiment, a storage area is reserved in a cache area of the battery-backed-up main memory device (memory 1), and that of the battery-backed-up cache memory (memory 2) in the input/output module (IO module) 130.

Moreover, in the third embodiment, a storage area is reserved in a cache area of the memories of its own system, i.e., the battery-backed-up main memory device (memory 1), and the battery-backed-up cache memory (memory 2) in the input/output control module (IO module) 130, and in a cache area of the memories of any other system, i.e., the battery-backed-up main memory device (memory 1), and the battery-backed-up cache memory (memory 2) in the input/output control module (IO module) 130.

Thereafter, in step 602, the write (Write) date is stored in the cache, and the data is subjected to a process for dual writing into the cache areas (memories 1 and 2). The status information in the storage area management table is then updated, and this is the end of the write (Write) process. The data written in the cache areas (memories 1 and 2) is read, if needed, from the cache areas (memories 1 and 2) at a predetermined timing, and a destaging process is executed for data writing into the disk drives 31 and 32 of the storage device 30.

Note that, described in the above is the case in which an input/output command (IO) coming from the host computer 20 is received, a CMD (Command) process is then executed for making an IO type determination, i.e., determining whether the command is for a write (Write) process or for a read (Read) process, and when the command is for the write (Write) process, the dual writing of data is performed. Alternatively, at the time when the input/output command (IO) coming from the host computer is received, and at the time when the data type determination is made, a determination may be made whether the transmitting data is control data or not. When the determination result tells that the transmitting data is control data, a data storage area may be reserved in a nonvolatile memory or a battery-backed-up volatile memory for dual writing of the control data.

FIG. 7 is a detailed flowchart of a storage area reservation process of the data write (Write) process in the storage control apparatus of the invention. FIG. 7 corresponds to step 601 of the data write (Write) process of FIG. 6. In FIG. 7, when the storage area reservation process of the data write (Write) process is started, in step S701, the storage area management table is located and referred to. The storage area management table corresponds to the memory management table 200 and the memory address data table of FIG. 2, for example. The memory management table 200 stores therein information about head addresses, end addresses, management units, usages, and others in the columns of 201 to 204. The memory address data table 210 stores therein information about cache addresses, drive numbers, drive addresses, statuses, and others in the columns of 211 to 214.

The storage area management table is stored, as the management information, in the battery-backed-up main memory device (memory 1) in the first embodiment of FIG. 1, for example, and is stored in the cache memory (memory 2) in the second and third embodiments of FIGS. 3 and 4, for example. The storage area management table is located and referred to by the Central Processing Unit (CPU) 110 in charge of software control over input/output, or by the input/output control device (IOCTL) in charge of hardware control over input/output.

Then in step 702, an area of a size of data is reserved in a battery-backed-up nonvolatile memory, and this is the end of the storage area reservation process of the data write (Write) process. For the data write (Write) process, it is especially significant to reserve a memory area that is sufficiently large in size for a write-destination address area to completely store data, and is nonvolatile, i.e., memory area in which any data stored therein is not erased even if the power supply is turned off.

FIG. 8 is a detailed flowchart of the data read (Read) process in the storage control apparatus of the invention. In FIG. 8, when the data read (Read) process is started, in step 801, a determination is made whether the data requested by the host computer 20 for reading is found on the memory or not.

Similarly to the data write (Write) process, the data read (Read) process can be executed also by hardware control by the input/output control device (IOCTL) 180 of the input/output control module (IO module) 130. Moreover, even after the power supply is turned off, during a predetermined period of time of BBU, the data read process can be performed by software control by the Central Processing Unit (CPU) 110 using the input/output control program 141 stored in the battery-backed-up main memory (memory 1).

In step 801, when the data is found on the memory, i.e., Yes, the procedure goes to step 804, and in step 804, the data requested as such is transferred to the host computer 20. This is the end of the data read (Read) process.

Then instep 801, when the data is not found on the memory, i.e., No, the procedure goes to step 802, and in step 802, a storage area is reserved in a volatile memory. Then in step 803, a staging process is executed for storing the data from the storage device (drive) 30 to the volatile memory. For the data read (Read) process, the dual writing of data is not performed. Then in step 804, the requested data in the volatile memory, i.e., staged data, is transferred to the host computer, and this is the end of the data read (Read) process.

FIG. 9 is a detailed flowchart of the storage area reservation process of the data read (Read) process in the storage control apparatus of the invention. FIG. 9 corresponds to step 802 of the data read (Read) process of FIG. 8. In FIG. 9, when the storage area reservation process of the data read (Read) process is started, in step 901, the storage area management table is located and referred to, and then in step 902, an area of a size of data is reserved in a volatile memory. This is the end of the storage area reservation process of the data read (Read) process.

The storage area management table corresponds to the memory management table 200 and the memory address data table of FIG. 2, for example. The memory management table 200 stores therein information about head addresses, end addresses, management units, usages, and others in the columns of 201 to 204. The memory address data table 210 stores therein information about cache addresses, drive numbers, drive addresses, statuses, and others in the columns of 211 to 214.

The storage area management table is stored, as the management information, in the battery-backed-up main memory device (memory 1) in the first embodiment of FIG. 1, for example, and is stored in the cache memory (memory 2) in the second and third embodiments of FIGS. 3 and 4, for example. The storage area management table is located and referred to by the Central Processing Unit (CPU) 110 in charge of software control over input/output, or by the input/output control device (IOCTL) in charge of hardware control over input/output.

FIG. 10 is a detailed flowchart of a drive data transfer process for data back-up in the storage control apparatus of the invention, and for remote copy therein. In FIG. 10, when the data transfer process is started, in step 1001, the storage area reservation process is executed to the cache memory (memory 2) of the input/output control module (IO module) 130 of the storage control apparatus 100, or to the memory of any other system, i.e., the storage control apparatus 101.

Then in step 1002, data reading (Read) is performed from the storage device (drive) 30, and then data writing (Write) is performed to the memory, e.g., the battery-backed-up main memory (memory 1) 120 in the first embodiment. The staging process is then executed for data reading from the storage device (drive) 30 to the volatile memory.

Then in step 1003, the data transfer process is executed for transferring the staging data in the volatile memory to the memory 2 or to the memory in any other system, and then in step 1004, a storage area release process is executed to the volatile memory. This is the end of the data transfer process.

By executing the processes in steps 1001 to 1004 in the data transfer process during a predetermined period of time in which the memory can maintain the nonvolatility of data due to battery back-up, even if the power supply is turned off, data can remain intact, and the data transfer process can be executed with swiftness and efficiency.

In the storage control apparatus and the storage system of the invention, the various types of memories are coupled together over the network, and the compatibility is provided with the storage systems under the control of the Central Processing Unit including the main memory device so that the entire system can be power efficient and high in speed, and the memory devices can remain reliable and high in use efficiency.

What is claimed is:

1. A storage control apparatus, comprising:
a central processing unit coupled with a main memory device;
a channel interface device to be coupled with a host computer;
a disk interface device to be coupled with a disk drive unit; and
an input/output control device coupled with a memory device, wherein
the main memory device is configured by a volatile memory that is battery backed-up to maintain nonvolatility of data for a predetermined period of time after a power supply is turned off,
the battery-backed-up main memory device and the memory device coupled with the input/output control device form a memory address space for use as a cache device of the storage control apparatus,
a staging process is executed for reading data stored in the disk drive unit, and for writing the data into the cache device, and
a destaging process is executed for reading data stored in the cache device, and for writing the data into the disk drive unit.

2. The storage control apparatus according to claim 1, wherein
in response to a request command coming from the host computer, an input/output command and input/output data are each defined by type, and a data input/output process is executed in a different manner depending on the type of the input/output command and that of the input/output data.

3. The storage control apparatus according to claim 2, wherein
when the input/output command is defined as being a write command, a storage management table is located and referred to, and an area of a size of data is reserved in the battery-backed-up main memory device for dual writing of data, and
when the input/output command is defined as being a read command, an area of a size of data is reserved in the battery-backed-up main memory device for storage of data coming from the disk drive unit, and data on request is transferred to the host computer.

4. The storage control apparatus according to claim 1, wherein
when a request command coming from the host computer is for a data transfer process, a storage area is reserved in the memory device coupled with the input/output control device or in a remote memory device of an other system, and after data read from the disk drive unit to the battery-backed-up main memory device is transferred to the memory device coupled with the input/output control device or to the remote memory device of the other system, a storage area of the battery-backed-up main memory device is released.

5. A storage control apparatus, comprising:
a central processing unit coupled with a main memory device;
a channel interface device to be coupled with a host computer;
a disk interface device to be coupled with a disk drive unit; and
an input/output control device coupled with a memory device, wherein
the main memory device and the memory device coupled with the input/output control device are each configured by a volatile memory that is battery backed-up to maintain nonvolatility of data for a predetermined period of time after a power supply is turned off,
the battery-backed-up main memory device and the battery-backed-up memory device coupled with the input/output control device form a memory address space for use as a cache device of the storage control apparatus,
a staging process is executed for reading data stored in the disk drive unit, and for writing the data into the cache device, and
a destaging process is executed for reading data stored in the cache device, and for writing the data into the disk drive unit.

6. The storage control apparatus according to claim 5, wherein
in response to a request command coming from the host computer, an input/output command and input/output data are each defined by type, and a data input/output process is executed in a different manner depending on the type of the input/output command and that of the input/output data.

7. The storage control apparatus according to claim 6, wherein
when the input/output command is defined as being a write command, a storage management table is located and referred to, and an area of a size of data is reserved in the battery-backed-up main memory device and in the battery-backed-up memory device coupled with the input/output control device for dual writing of data, and
when the input/output command is defined as being a read command, an area of a size of data is reserved in the battery-backed-up main memory device and in the battery-backed-up memory device coupled with the input/output control device for storage of data coming from the disk drive unit, and data on request is transferred to the host computer.

8. The storage control apparatus according to claim 5, wherein
when a request command coming from the host computer is for a data transfer process, a storage area is reserved in the memory device coupled with the input/output control device or in a remote memory device of an other system, and after data read from the disk drive unit to the battery-backed-up main memory device and to the battery-backed-up memory device coupled with the input/output control device is transferred to the memory device coupled with the input/output control device or to the remote memory device of the other system, a storage area of the battery-backed-up main memory device and that of the battery-backed-up memory device coupled with the input/output control device are released.

9. A storage system, comprising:
a plurality of storage control apparatus each including:
a central processing unit coupled with a main memory device;
a channel interface device to be coupled with a host computer;
a disk interface device to be coupled with a disk drive unit; and
an input/output control device coupled with a memory device;
the host computer coupled with each of the storage control apparatuses via the channel interface devices thereof; and
the disk drive unit coupled with each of the storage control apparatuses via the disk interface devices thereof, wherein
the main memory device and the memory device coupled with the input/output control device of each of the plurality of storage control apparatuses are each configured by a volatile memory that is battery backed-up to maintain nonvolatility of data for a predetermined period of time after a power supply is turned off,
the battery-backed-up main memory device and the battery-backed-up memory device coupled with the input/output control device of the storage system, and a battery-backed-up main memory device and a battery-backed-up memory device coupled with an input/output control device of an other system form a memory address space for use as a cache device of the storage system,
a staging process is executed for reading data stored in the disk drive unit, and for writing the data into the cache device, and
a destaging process is executed for reading data stored in the cache device, and for writing the data into the disk drive unit.
